(19) United States
(12) Patent Application Publication
(10) Pub. No.: US 2014/0217267 A1
(43) Pub. Date: Aug. 7, 2014

(54) METHOD AND DEVICE FOR COUPLING A LIGHT BEAM INTO A FOIL

(71) Applicants: Johannes Joseph Hubertina Barbara Schleipen, Eindhoven (NL); Jacobus Hermanus Maria Neijzen, Heeze (NL)

(72) Inventors: Johannes Joseph Hubertina Barbara Schleipen, Eindhoven (NL); Jacobus Hermanus Maria Neijzen, Heeze (NL)

(73) Assignee: KONINKLIJKE PHILIPS N.V., Eindhove (NL)

(21) Appl. No.: 14/342,045

(22) PCT Filed: Sep. 3, 2012
(86) PCT No.: PCT/IB2012/054540

§ 371 Date: Feb. 28, 2014

Related U.S. Application Data
(60) Provisional application No. 61/531,122, filed on Sep. 6, 2011.

(51) Int. Cl. F21V 8/00; G01J 1/04

(52) U.S. Cl. CPC G02B 6/003; G01J 1/0407
USPC 250/216; 362/608

(57) ABSTRACT

The invention relates to a method and an optical device (150) in which a light beam (L) is coupled into a transparent component, for example into a foil (110). The incoupling is achieved by astigmatically focusing a light beam (L) onto an oblong entrance window (W) of the foil (110), wherein a focal line (Fx) of the light beam (L) is oriented along the axis (x) of extension of the entrance window (W). Preferably, a second focal line (Fy) of the light beam (L) is disposed inside the transparent component (110) below a region of interest (112).

### FIELD OF THE INVENTION

The invention relates to a method and an optical device for coupling a light beam into a transparent component, particularly into a planar component like a foil.

### BACKGROUND OF THE INVENTION

The WO 2009/016533 A2 discloses a microelectronic sensor device for making optical examinations in a cartridge, particularly for the detection of magnetic particles by frustrated total internal reflection (FTIR). The cartridge comprises entrance and exit windows for the light that have particular inclinations with respect to the plane of the cartridge.

### SUMMARY OF THE INVENTION

It is an object of the invention to provide means that allow an efficient incoupling of light into a planar transparent component and that can cost effectively be realized.

This object is achieved by a method according to claims 1 and 2, an optical device according to claim 3, and a use according to claim 13. Preferred embodiments are disclosed the dependent claims.

A method of the present invention allows the incoupling of a light beam into a transparent component through which the light beam can pass, said component having an oblong entrance window with a given axis of extension. The actual shape of the entrance window is quite arbitrary, though it will typically be rectangular (or at least comprise a rectangular area) with a length extending along said extension axis of the window and a width that is smaller than said length. A typical aspect ratio of the entrance window (i.e. ratio between length and width) ranges between about 20:1 and 3:2.

The method comprises the astigmatic focusing of the light beam onto the entrance window such that a focal line (typically the first of two focal lines) extends along the axis of the entrance window.

In this context, the term “astigmatic focusing” means the focusing of a (e.g. symmetric) light beam such that—even theoretically—not all rays of the light beam meet at the same focal point. Instead, there is at least one 1-dimensional line segment (called “focal line” in the following) through which the rays of the light beam pass. Usually two such focal lines can be identified that are oblique (typically perpendicular) to each other and spaced apart along the optical axis.

Moreover, the extension of the (first) focal line along the axis of the entrance window shall mean that the angle between the (first) focal line and the axis of the entrance window is less than about 45°, preferably less than about 20°. Most preferably, the focal line and the axis of the entrance window are substantially parallel (wherein tolerance on the orientation depends on the actual shape of the focal line, defined by incoupling NA and first and second focal lengths and the height of the entrance window).

After coupling in the light in a planar optical component using the first focal line, the light will be guided inside the component along the optical axis using total internal reflection. As a result a region of high intensity will arise inside the component, at the position of the second focal line, a macroscopic distance away from the entrance window, this distance given by the difference between the two focal lengths of the astigmatic optics. These features are mainly relevant for thin optical components (e.g. cartridges) having a sensor zone several millimeters away from the component's edges.

The invention further relates to an optical device comprising two main components, namely:

a) An accommodation space (or holder) where a transparent component having an oblong entrance window can be disposed or where it is disposed. In the first case (“can be”), the transparent component will typically be an exchangeable element that does not belong to the optical device. In the second case (“is”), the transparent component may be permanently arranged at the accommodation space and may be considered as a part of the optical device.

b) Focusing optics for astigmatically focusing a light beam onto the entrance window of the transparent component at the accommodation space such that a (preferably first) focal line extends along the axis of the entrance window.

The methods and the optical device are related embodiments of the present invention. Explanations and definitions provided for one of these embodiments are therefore valid for the other one, too.

The methods and the optical device have the advantage that they allow for the incoupling of a complete light beam into a planar transparent component using an oblong entrance window, which is usually available even for simple shapes of the transparent component. The oblong shape of such an entrance window is optimally exploited by using an astigmatic focusing of the light beam with a focal line extending along the axis of said window. This leaves freedom with respect to other focal characteristics of the light beam, particularly with respect to a second focal line as will be explained in more detail below.

In the following, various embodiments of the invention will be described that relate to the methods and the optical device described above.

It was already mentioned that an astigmatically focused light beam usually comprises a second focal line. In a preferred embodiment of the invention, the optical design parameters are chosen such that a second focal line is located inside the transparent component. This allows to generate inside said transparent component an area where all light rays are concentrated.

In general, the transparent component may have any three-dimensional shape as long as the oblong entrance window is provided. Moreover, the waveguiding condition for total internal reflection is preferably fulfilled. In a preferred embodiment, the transparent component is a plate or sheet of (transparent) material, thus having a form that can most easily be realized. In particular, the transparent component may be a foil, preferably a foil with a thickness between about 50 μm and about 1000 μm. A disposable cartridge in which a sample can be provided for an optical investigation can for example effectively be realized with such a foil.

The design of the transparent component and the focusing optics is preferably such that the light beam—or at least one ray of the light beam—is at least once totally internally reflected inside the transparent component. In this way the light beam or parts of it may propagate inside the transparent component without losses and thus reach target regions remote from the entrance window. Preferably the light beam is totally internally reflected several times, for example at two opposite surfaces, thus propagating as in a waveguide.

The aforementioned design can for example be achieved if the NA belonging to the first focal line is less than a maximum value NAₘₐₓ, guaranteeing total internal reflection inside the transparent component, thereby acting as a waveguide. This maximum value can be assumed as:

NAₘₐₓ=\sqrt{n²_{component}−n²_{surrounding}},

with n_{component} the refractive index of the transparent component and n_{surrounding} the maximum refractive index of the surrounding media of the transparent component (e.g. air below and water above, in which case n_{surrounding}=n_{water}).

According to another embodiment, the transparent component comprises a surface with a detection region at which the light beam is totally internally reflected (after entering the transparent component). This allows to exploit the generation of evanescent waves that are caused by total internal reflection, e.g. for the illumination of a limited region close to the reflection surface. Thus target components of a sample may for example be detected by frustrated total internal reflection. Most preferably, the above mentioned second focal line of the astigmatically focused light beam may be located at the detection region such that this region is reached by all light rays of the light beam, wherein the second focal line is preferably oriented perpendicular to the detection region.

In order to achieve an astigmatic focusing of a light beam, the focusing optics may comprise an astigmatic lens, for example a cylindrical lens.

The light beam that is astigmatically focused may in principle originate from any source, for example from ambient light. Most preferably, the optical device comprises however a (technical) light source for controllably generating the light beam. The light source may for example be a laser or a light emitting diode (LED), optionally provided with some optics for collimating the light beam. The NA of the focused light beam should be small enough, preferably less than NAₘₐₓ previously defined, in order to fulfill the conditions for total internal reflection.

When measurements or detection processes are intended, a light detector will usually be added for detecting light leaving the transparent component. This light may particularly originate from the light beam that was coupled into the transparent component, i.e. it may consist of (e.g. reflected or scattered) photons of this light beam or (e.g. fluorescence) photons that were induced by this light beam. The detector may comprise any suitable sensor or plurality of sensors by which light of a given spectrum can be detected, for example photodiodes, photo resistors, photocells, a CCD chip, or a photo multiplier tube.

According to a further development of the aforementioned embodiment, an evaluation unit is provided for the processing and evaluation of the signals of the light detector. The evaluation unit may for example be realized by dedicate electronic hardware, digital data processing hardware with associated software, or a combination of both.

Furthermore, a magnetic field generator (e.g. a permanent magnet or an electromagnet) may be provided for generating a magnetic field inside the transparent component and/or in the space adjacent to it. With such a magnetic field it is for example possible to manipulate magnetically labeled target components in a sample that is close to the transparent component.

The invention further relates to the use of the optical device described above for molecular diagnostics, biological sample analysis, chemical sample analysis, food analysis, and/or forensic analysis. Molecular diagnostics may for example be accomplished with the help of magnetic beads or fluorescent particles that are directly or indirectly attached to target molecules.

### BRIEF DESCRIPTION OF THE DRAWINGS

These and other aspects of the invention will be apparent from and elucidated with reference to the embodiments described hereinafter.

In the drawings:

FIG. 1 illustrates schematically in a perspective view the incoupling of a light beam into a foil with a spherical lens;

FIG. 2 shows a top view of the setup of FIG. 1;

FIG. 3 illustrates schematically in a perspective view an optical device in which a light beam is astigmatically coupled into a foil;

FIG. 4 shows a top view of the setup of FIG. 3;

FIG. 5 illustrates geometrical parameters that are used for calculations;

FIG. 6 is a diagram showing the focal lengths and the beam diameter as a function of the numerical aperture;

FIG. 7 is a perspective illustration of the astigmatically focused light beam;

FIG. 8 comprises formula used for the derivation of design parameters.

Like reference numbers refer in the Figures to identical or similar components.

### DETAILED DESCRIPTION OF EMBODIMENTS

The WO 2009/016533 A2 (which is incorporated into the present application by reference) describes an immuno-assay biosensing technology based on optical detection of superparamagnetic nanoparticles. Here, the magnetic properties of the nanoparticles are being used for (i) speeding up the diffusion process of analytes towards the detection surface and (ii) enabling a magnetic washing step where unbound nanoparticles are extracted from the detection zone prior to the optical detection. For detection frustrated total internal reflection may be used. Moreover, dark field detection of scattered light from substrate bound nanoparticles, also called single bead detection, may be used.

In the mentioned technologies a disposable plastic injection molded cartridge is used, comprising e.g. a blood filter, microfluidics for transportation of blood plasma towards a detection chamber, said detection chamber containing buffer constituents and nanoparticles, and optical windows for coupling in the excitation light needed for total internal reflection, and coupling out the frustrated total internal reflected (FTIR) beam for FTIR detection or the scattered light of bound nanoparticles for dark field detection.

It would be desirable if foil based cartridges could be used as this allows massive parallel roll-to-roll manufacturing and thereby eliminating the need for the relatively expensive injection moulding technology. One of the issues confronted with in going towards foil based optical cartridges is the incoupling of light needed for creating an evanescent field. The known injection molded cartridges are equipped with an entrance and exit window, requiring a complex, non-flat component.

The problem to be solved is therefore: How to couple in light inside a foil substrate,

(i) such that an evanescent field is being created at the position of the detection chamber,

(ii) with sufficiently high intensity at a well localized spot, and

(iii) without the need for additional complex structures like gratings or prisms.

The main goal is to use a standard blank optical foil without additional grating, prism or waveguide structures. When focusing a beam of light inside the foil, the focusing optics has to obey two basic rules: (i) the optical spot at the foil's edge should be smaller than the thickness h of the foil, and (ii) the numerical aperture of the focused beam should be small enough such that the incoupled light is totally internally reflected at the bottom and top surface of the foil.

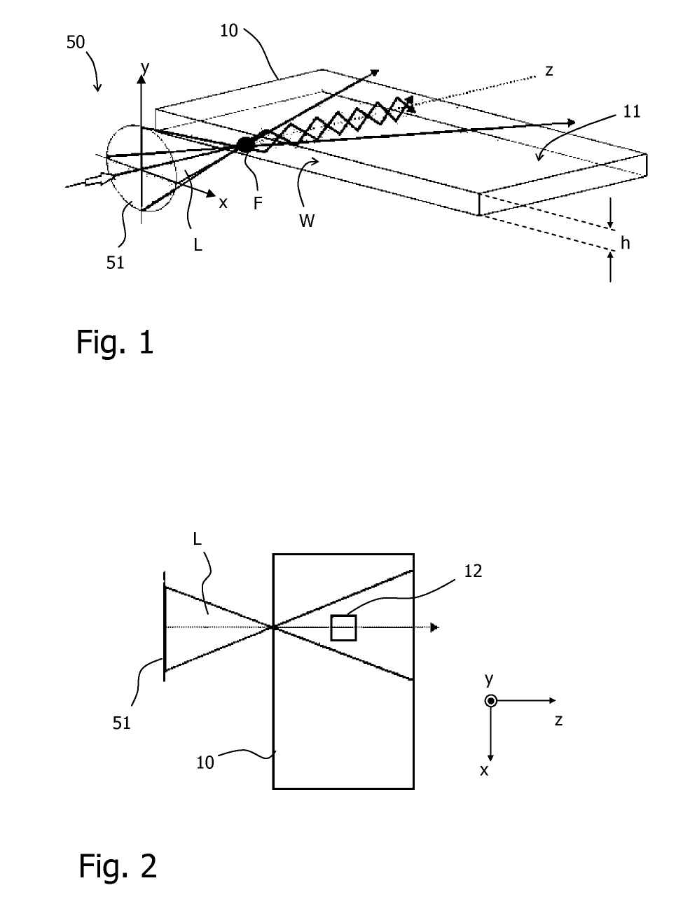

FIGS. 1 and 2 illustrate what happens when the aforementioned approach is realized with a spherical lens 51 for focusing a light beam L into a planar transparent foil 10. The side face of the foil 10 (or a sub-region thereof) constitutes an oblong entrance window W with a long extension axis (x-axis) and a width h (in y-direction). The beam waist is positioned at the edge of the foil 10 and from that point F onwards the beam is diverging again, causing a decreased intensity at the area 12 of interest, located at some distance from the edge of the foil 10.

In order to solve this, meaning

(i) coupling all light inside the foil by focusing at the foil's edge, and

(ii) still creating a focus point at the area of interest,

it is proposed to use astigmatic optics such as a cylindrical lens.

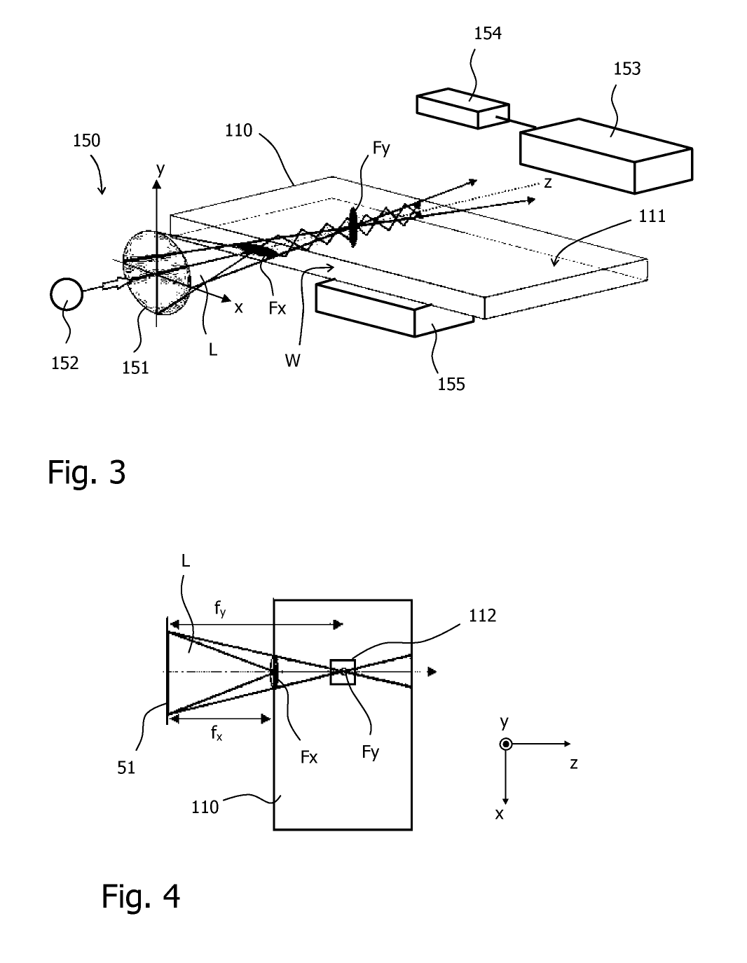

FIG. 3 schematically shows an optical device 150 according to this idea. This optical device 150 comprises two main components, namely:
A transparent component, here realized by a transparent foil 110 (as in FIGS. 1 and 2). Usually this foil will be an exchangeable (disposable) component or cartridge with which a sample to be investigated can be provided and that is discarded after one use. The optical device 150 therefore typically comprises just a holder or accommodation space for such a foil or cartridge 110, while the cartridge itself constitutes an independent element separate from the optical device.
Focusing optics, here realized by an astigmatic lens 151.

FIG. 3 further indicates a light source 152 for generating a collimated (parallel) light beam that is astigmatically focused by the lens 151 into a light beam L.

The astigmatic lens 151 focuses the incoming parallel light such two focal lines Fx and Fy are created at position z=fx and z=fy from the lens, respectively. The first focal line Fx at fx is oriented in the xz-plane, it may have a certain length lx, but its height by is definitely smaller than the foil thickness h. Consequently all light may be coupled inside the foil 110, and if the numerical aperture (NA) is small enough, all light will be transported inside the foil 110 by total internal reflection. The second focal line Fy at fy is oriented in the xy-plane, preferably along the y-axis, having a certain length ly and width hx which is governed by the NAx and NAy inside the foil and the astigmatic distance |fy−fx|. Although this focal line is directed along the y-direction, still all light is confined within the foil 110 and this focal line is “folded onto itself” by the total internal reflection. As the top view in FIG. 4 shows, all light of the light beam L can thus be transferred to the region of interest 112.

FIG. 3 further shows schematically a light detector 153 for the detection of light leaving the foil 110. The signals of this light detector 153 are transferred to an evaluation unit 154 for processing and evaluation, for example with respect to the amount of target components of a sample that are attached to the region of interest 112. Furthermore, a magnetic field generator 155 that is disposed below the foil 110 is indicated. This allows to generate a magnetic field with which magnetic particles inside a sample above the foil 110 can be manipulated.

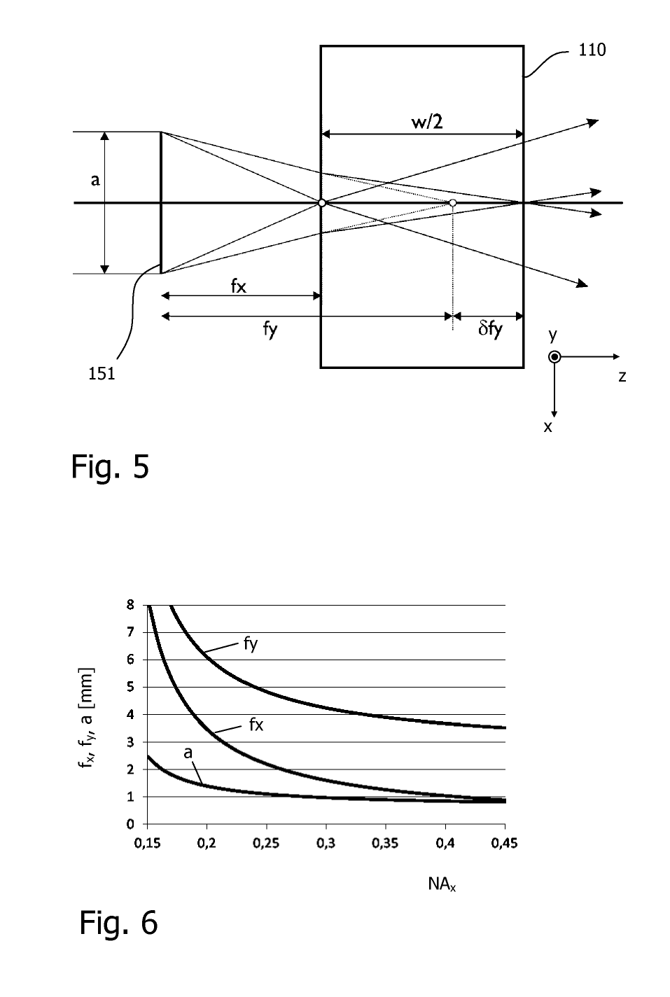

FIG. 5 illustrates the definition of geometrical variables used in the following when the proposed incoupling geometry is dimensioned applying geometrical optics formulas for astigmatic optics. The design parameters are the focal lengths fx and fy of the astigmatic lens 151, and the diameter a of the incoming beam. The experimental constraints are given by (i) the condition for total internal reflection inside the foil, (ii) the position of the beam waist measured from the foil edge (in this case halfway the foil, the foil having a width w) and (iii) the width of the focal line at fx when entering the foil.

Design parameters: fx, fy and a

Constraints:

(i) NAₓ should be sufficiently small in order to enable TIR inside the foil: NAₓ<NA_{TIR}. Given a refractive index n of the foil, and a refractive index nₜ of the material directly on top of the foil (might be a thin layer of optical glue) the maximum allowed incoupling numerical aperture, NA_{TIR}, equals:

Na_{TIR}=\sqrt{n²−nₜ²}

(ii) The focal line Fx at fx should coincide with the edge of the cartridge.

(iii) Due to refraction the focal line Fy at fy will shift an amount δfy inside the cartridge. This amount is given by (n is the refractive index of the foil):

δfy=(n−1)·(fy−fx)

The second focal line Fy at fy is preferably located at the center of the cartridge (i.e. at the sensor area 112); given a cartridge width w, this results in

fy+δfy−fx=w/2 or fy−fx=w/(2·n)

In order to illuminate a multitude of different detection zones inside the cartridge along the x-direction, separated over some distance xd, the diameter of the respective astigmatic lenses may not exceed this value xd. In a real application the incoupling lenses are preferably positioned close to the cartridge entrance window, resulting in a corresponding certain maximum value for lx. The length lx of the first focal line Fx at fx should have a certain maximum value: lx=lmax. This results in the equations (1) and (2) reproduced in FIG. 8. Combining these two equations results in equation (3) of FIG. 8. Substituting this into equation (2), this results in the shown final set of equations describing the focal lengths fx, fy of the astigmatic optics and the diameter a of the incoming beam.

It should be noted that in general the numerical apertures of the astigmatic optics in x and y direction do not necessarily need to be the same: NAx (i.e. the entrance angle at Fx in the yz-plane) is determined by the condition for total internal reflection; NAy (i.e. the entrance angle at Fy in the xz-plane) determines the ultimate width of the focused spot at position Fy.

In order to couple in all light at the entrance facet at position fx, the NA of the beam in the y direction should be sufficiently large such that the height of the line focus Fx is less than the thickness of the cartridge h:

1.22λ/NA_{y}<h; NA_{y}>1.22λ/h

One more implementation requirement might be a reasonably small beam diameter a, such that more beams can be positioned next to each other (in x-direction), thereby creating a multitude of spots inside the foil. This might be advantageous for a biosensor application with more than one readout spots (e.g. in the case of multi-chamber and/or multi-spot multiplexing).

For a numerical example, the following values may hence be assumed:
A typical value for the beam diameter should be a=1 mm.
A typical value for the cartridge/foil width is w=8 mm.
The foil refractive index is n=1.51.
The glue refractive index is nₜ=1.4.

This results in a maximum value for NA_{TIR}=0.54.

FIG. 6 illustrates the focal lengths fx, fy and the beam diameter, a, as function of entrance NAx (for the above parameters and a length of the first focal line lx=0.6 mm).

From this one can conclude that a lens with focal lengths fy=4.4 mm, fx=1.8 mm, and beam diameter a=1.0 mm allows a maximum incoupling NA of 0.28 at the entrance of the cartridge. The width of the first focal line in this case is lx=600 μm.

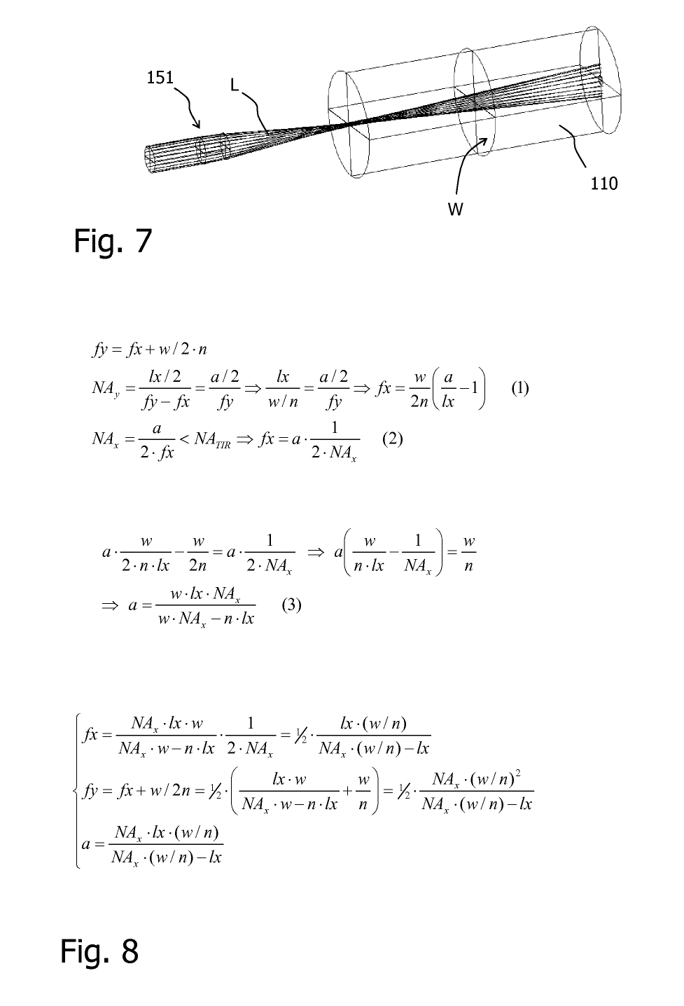

In order to further study the quality of such an optical system a raytrace simulation has been carried out, using these parameters. FIG. 7 illustrates the 3D layout of the optical geometry of this simulation (not showing total internal reflection).

To verify the invention experimentally, a plastic optical cartridge has been constructed made of optical grade PMMA foil. Light has been coupled into the TIR layer of this cartridge using the combination of a spherical and a cylindrical lens. A camera was looking at the top of the cartridge monitoring the scattering of the incoupled light at the bottom side of the TIR layer. The scattered light that could be observed clearly indicates the focusing of the incoupled light inside the TIR layer using astigmatic optics.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for coupling a light beam (L) into a transparent component having an entrance window (W) extending along an axis (x), said method comprising the astigmatic focusing by an astigmatic lens of said light beam (L) onto the entrance window (W) such that
a focal line (Fx) extends along an axis (x) of the entrance window (W),
a second focal line (Fy) of light beam (L) extends along an axis y, said axis y, being orthogonal to axis x and located inside the foil,
the light beam (L) is at least once totally internally reflected inside the foil.
wherein the transparent component comprises a surface with a detection region characterized in that second focal line (Fy) is located at the detection region

2. (canceled)

3. An optical device comprising:
a) an accommodation space where a transparent component having an oblong entrance window (W) extending along an axis (x) is or can be disposed;
b) focusing optics for astigmatically focusing a light beam (L) onto said entrance window (W) such that a focal line (Fx) extends along the axis (x) of the entrance window (W).

4. The method according to claim 1,
characterized in that a second focal line (Fy) of the astigmatic light beam (L) is located inside the transparent component.

5. The method according to claim 1,
characterized in that the transparent component is a plate or sheet of material, particularly a foil with a thickness between about 50 μm and about 1000 μm.

6. The method according to claim 1,
characterized in that the light beam (L) is at least once totally internally reflected inside the transparent component.

7. (canceled)

8. The method according to claim 1
characterized in that an astigmatic lens is provided for the focusing of the light beam (L).

9. The method according to claim 1,
characterized in that a light source is provided for generating the light beam (L).

10. The method according to claim 1,
characterized in that a light detector is provided for detecting light leaving the transparent component, particularly light that originates from the incoupled light beam (L).

11. The method or the optical device according to claim 10,
characterized in that an evaluation unit is provided for processing the signals of the light detector.

12. The method according to claim 1,
characterized in that a magnetic field generator is provided for generating a magnetic field inside and/or adjacent to the transparent component.

13. Use of the optical device according to any of the claims 3 for molecular diagnostics, biological sample analysis, chemical sample analysis, food analysis, and/or forensic analysis.

14. The optical device according to claim 3,
characterized in that a that a light source is provided for generating the light beam (L).
